(19) United States
(12) Patent Application Publication
(10) Pub. No.: US 2021/0073219 A1
(43) Pub. Date: Mar. 11, 2021

(54) DATABASE QUERY DATA REDUNDANCY NULLIFICATION

(71) Applicant: International Business Machines Corporation, Armonk, NY (US)

(72) Inventors: Pedro Miguel Barbas, Dunboyne (IE); David Kelly, Robertstown (IE); Breda Fawle, Dublin (IE); Debbie Corcoran, Dublin (IE)

(21) Appl. No.: 16/564,332

(22) Filed: Sep. 9, 2019

(51) Int. Cl. G06F 16/2453; G06F 16/22

(52) U.S. Cl. CPC G06F 16/2453; G06F 16/2282

(57) ABSTRACT

A database query can be performed on a database with data redundancy nullification. A probabilistic data structure filter, such as a Bloom filter, can be created from each query statement, where the filter specifies consultation to data in tables of the database at the row and column level. The filter can be applied to remove data from the tables that are redundant to the query statement, thereby generating a filtered subset of the table data. The query statement can then run against the filtered subset of the table data, where the consultation avoids consultation to the redundant data

### BACKGROUND

The term “data redundancy nullification” can be understood to include measures taken to ensure that when a database query is run against a database, no processing effort is expended on sweeping over data that can have no effect on the query result. Such data content, if absent from the query, does not change the data set returned in response to running the query.

A database can assume the form of one or more tables, where each table can include rows and columns. More generically, a table can be a specific kind of data container, a row can be a specific kind of record, and a column can be a specific kind of field.

A database can be custom designed for a specific “use case.” Example use cases can include databases for handling mission-critical transactional workloads, non-relational databases for flexible and extensible mobile and web applications or “apps,” and data warehousing databases optimized for fast processing of queries. Modern enterprises often deploy mission-critical transactional databases which can include several hundred GB, and often several TB of data. Database users have expectations for increasingly rapid query response times when they submit database queries.

Structured Query Language (SQL) is a widely used data access language for interrogating or querying databases. A database query can be in the form of a SQL statement. SQL statements can contain join types, such as inner joins, outer joins, semi-joins and anti-joins. A query can be implemented based at least in part on detected join conditions. Various keywords, e.g., DISTINCT, can also be included in a query statement as a directive to eliminate duplicate rows from the join results.

Database queries can be subdivided into one or more query data blocks. Each query data block can be a subset or a set of data. For example, in the case of a table, a query data block can be the whole table or a part of a table. Moreover, a query data block from a query could be a subquery in a broader query, or it could be the broader query itself.

Query data redundancy is present when the dataset of the result is unaffected by the presence or absence of at least one element in the query. It is therefore desirable to nullify data redundancy in the query statement before the query is submitted, in order to improve the processing speed of the query. Consider the following SQL statement with tables T1 and T2 as an example:
SELECT SUM(DISTINCT T1.A), MIN(T2.C)
FROM T1, T2
WHERE T1.A=T2.B;

With this SQL statement, a database optimizer can consider the full amount of data from datasets T1 and T2 in order to produce the final result set. However, to get to the final result set, it is not necessary to consider the full amount of data from datasets T1 and T2 and this does not alter the semantics of the query statement. In fact, for tables T1 and T2, for columns A and B respectively, only distinct values need to be considered. Further, the condition MIN(T2.C) for table T2 indicates that only one row needs to be processed to get to the final result set. Any other rows used to process this query will be redundant, and this will hence merely increase the time needed to process the query by unnecessarily burdening the database engine.

### SUMMARY

Embodiments of the present disclosure can include a method, a system, and a computer program for implementing query redundancy nullification when consulting a database with a database query, where the redundancy nullification involves the use of a probabilistic data structure filter.

Embodiments can be directed towards a method of performing a database query on a database containing at least one table including rows and columns. The method includes receiving a query statement, creating a probabilistic data structure filter from the query statement. The probabilistic data structure filter can specify consultation to data in at least one table at a level of at least one of rows and columns. The method can also include removing any data from the at least one table that are redundant to the query statement. Data that are redundant to the query statement can be determined by applying the probabilistic data structure filter to generate a filtered subset of the at least one table. The method can also include performing consultation to the filtered subset based on the query statement, where the consultation avoids consultation to the redundant data, and returning a query result from the consultation.

Embodiments can also be directed towards a database management system including a database configured to store at least one table including rows and columns. The database management system can also include a processing node including a processor capable of running database queries against the database to generate a query result and a query processor having an input configured to receive database queries. The query processor can also include an output configured to output query results. The database management system can also include an interface to the processing node configured to supply database queries to and receive query results from the processing node. The processing node includes a filter unit operable to create a probabilistic data structure filter from a query statement, where the probabilistic data structure filter specifies consultation to data in at least one table at a level of at least one of rows and columns. The filter unit can also be operable to remove any data from the at least one table that are redundant to the query statement as determined by applying the probabilistic data structure filter to generate a filtered subset of the at least one table. The processor is operable to perform consultation to the filtered subset based on the query statement, where the consultation avoids consultation to the redundant data.

Embodiments can also be directed towards a computer program stored on a computer-readable medium and loadable into memory of a database management system, including software code portions, when said program is run on the database management system, for performing the above-described method. The disclosure further includes a computer program product storing the computer program.

Features of the method, system and computer program product in some embodiments include one or more of:
creating a probabilistic data structure filter relevant to a received query statement from a user, where the data structure filter specifies consultation to data in one or more tables in the database at a level of at least one of or a combination of: individual rows, individual columns,
certifying whether the probabilistic data structure filter is to be applied to the query statement request,
removing any redundant data, i.e., data that is not needed for processing the query statement, and
permitting consultation to the one or more tables based on the defined probabilistic data structure filter.

Embodiments of the method can include receiving a query statement, creating a probabilistic data structure filter relevant to the query statement, where the probabilistic data structure filter specifies consultation to data in one or more tables in the database at the level of at least one of or a combination of individual rows, individual columns. The method can also include certifying whether the probabilistic data structure filter is to be applied to the query statement request, removing any redundant data unnecessary to process the query statement and permitting consultation to the one or more tables based on the identified compelled probabilistic data structure filter definition.

The query statement may be a SQL query statement. The proposed approach can be implemented by interchanging probabilistic filters in memory to remove duplicates.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an example database management system suitable for implementing the proposed method.

FIG. 2 is a flow diagram depicting operations in a method according to the present disclosure.

FIG. 3 depicts a cloud computing environment, according to embodiments of the present disclosure.

FIG. 4 depicts abstraction model layers, according to embodiments of the present disclosure.

FIG. 5 depicts an example computer system, according to embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

In the drawings and the Detailed Description, like numbers generally refer to like components, parts, steps, and processes.

### DETAILED DESCRIPTION

The present disclosure relates to techniques for data redundancy nullification when processing database queries.

In the following detailed description, for purposes of explanation and not limitation, specific details are set forth in order to provide a better understanding of the present disclosure. It will be apparent to one skilled in the art that the present disclosure may be practiced in other embodiments that depart from these specific details.

A method and a system are described herein for achieving data redundancy nullification. Data redundancy nullification as described herein is implemented in a database management system (DBMS) by skipping over certain rows and/or columns in a database table when scanning the table in the course of applying a query statement that has associated therewith a filter specifying criteria to limit the search.

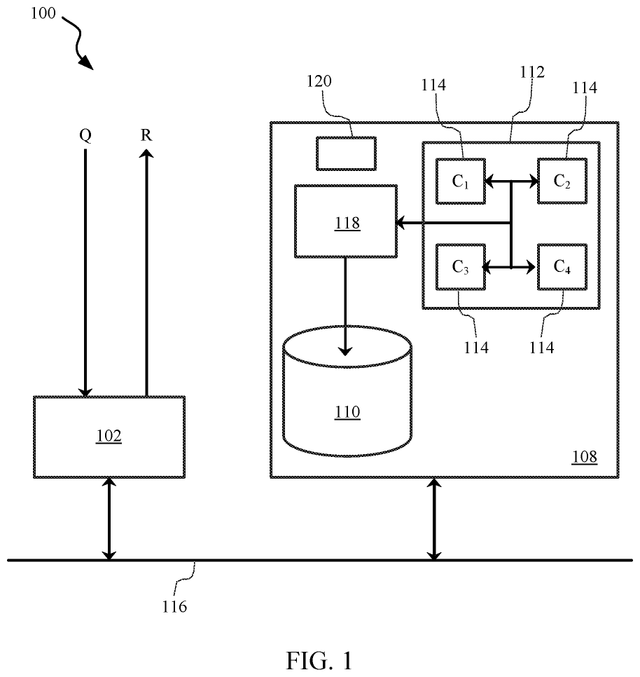

FIG. 1 illustrates, in simplified form, an example DBMS 100 suitable for implementing the proposed method. The system 100 is made up of a query processor 102 that receives queries 104 (“Q”), has them processed within the system 100, and returns results 106 (“R”). Specifically, the query processor 102 sends the query “Q” to a processing node 108 for processing. In FIG. 1, the query processor 102 is depicted for conceptual purposes as a separate and distinct unit from the processing node 108. However, it can be understood that the query processor 102 could itself be part of the processing node 108 or it could be running on a server that does not contain a processing node 108. It can be understood that multiple processing nodes could be provided, in which case the query processor 102 would be a distributed query processor whose task would include allocating queries and query tasks among the available processing nodes.

The processing node 108 includes storage 110, within which the database to be queried and its data are stored, and a processing unit 112, e.g., a CPU or multi-core processor, which may be of the type that is able to execute multiple processes or threads concurrently. The database may include multiple tables made up of outer table data and corresponding inner table data. As depicted in FIG. 1, for example, the processing unit 112 is a multi-core processor having four cores 114. A network connection or communication bus 116 interconnects the processing node 108, or multiple such processing nodes in a distributed system, and the query processor 102. The storage 110 stores format defining data structures, data-containing structures, and program instructions in a non-transitory manner, for example, such as non-transient solid-state memory, a magnetic hard drive, a tape drive, or an analogous or equivalent storage medium types.

In the case of a distributed system with multiple processing nodes 108, each processing node 108 has associated storage 110 where a portion of the distributed database is stored. As is known, the database portion that resides in the storage 110 includes multiple tables made up of outer table data and corresponding inner table data.

The processing node 108 includes a filter unit 118, which has the function of creating and then applying a Bloom filter 120, which is stored in the processing node 108, to the table data stored in the database 110. The Bloom filter is a custom filter created from and for each database query “on the fly.” Applying the Bloom filter to the table data generates a filtered subset of the table data, and it is only this filtered subset of the table data that is searched when the database query is run against the database. The filtered data subset may be stored locally in the processing node. Details of how the Bloom filter 120 is created are described below. The Bloom filter may be a standard Bloom filter or any known variant from the standard, such as a counting Bloom filter. The Bloom filter is a specific example of a probabilistic data structure filter. Other embodiments may use other types of probabilistic filter such as cuckoo filters or quotient filters. The Bloom filter 120 specifies consultation to the table data at the level of rows and/or columns. The role of the custom Bloom filter 120 is to remove any data from the table data that are redundant to the current query statement, so that when the query statement is run against the database the consultation is performed against the filtered subset of the table data, where the consultation avoids consultation to redundant data. A query result R is then returned from the consultation.

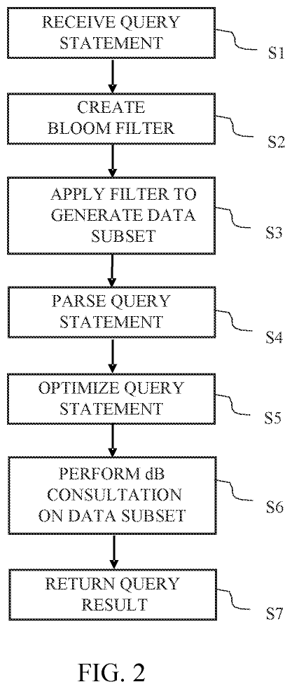

FIG. 2 is a flow diagram depicting operations of method for performing a database query according to the disclosure that may be performed using the system of FIG. 1. The query is performed on a database containing one or more tables, each table including one or more rows and columns.

In operation S1, a query statement is received. The query statement may be written in SQL, for example.

In operation S2, a Bloom filter or other suitable probabilistic data structure filter is created from the query statement. The filter can be implemented using a suitable known probabilistic data structure, several of which are freely available. Non-limiting examples of suitable probabilistic data structure filters are: standard Bloom filters, variants of standard Bloom filters, such as counting Bloom filters, cuckoo filters and quotient filters.

A Bloom filter, like other probabilistic data structure filters, is a filter which can be used to identify elements that are not a member of a set. A Bloom filter allows for the state of existence of a very large set of possible type values to be represented with a much smaller piece of memory by allowing for a certain degree of error. Application of a Bloom filter against an element gives a binary result, namely: the element is not in the set from which the Bloom filter was derived, or the element is a likely candidate to be in the set from which the Bloom filter was derived. It is therefore the case that application of a Bloom filter may result in false positives, but does not result in any false negatives.

It is contemplated that the filter can be custom-generated for each particular database query based on the syntax of the query statement. Given its custom nature, it is contemplated that the filter is created at run time “on the fly.” The filter specifies how the data in the database is to be consulted at the level of the structure of the database tables, i.e., the table rows and/or columns as may be specified individually, so that data that is redundant, i.e., can have no influence on the result based on the query, can be filtered out. The filter may be structured in a way that depends on the layout of the tables, in particular to mirror the table layout. The filter may be created blockwise, i.e., per data block. By data block we mean the smallest unit of storage that may be read out of or written into a database. For example, as is known, sets of filter data blocks may be based on filtering criteria defined in the summary of a data block set. The summary may contain the minimum and maximum values of a selected column in the data block set. This way, if a query is received by a DBMS with an equality predicate for a particular filtering value on the selected column, then the DBMS may first compare the particular filtering value with the in-memory summary of the data block set to determine whether the particular filtering value is within the maximum and the minimum. If the particular filtering value is outside the minimum and maximum value range, then the data block set may be skipped saving input/output (I/O) operations for scanning the data block set.

In operation S3, a subset of the database contents is determined by applying the filter to exclude data that is redundant, for example, any data from the table(s) that are redundant to the query statement as determined by applying the filter is removed.

In operations S4 & S5, the standard pre-processing operations of parsing and optimizing are performed on the query statement.

In operation S6, the query is run against the database, or more precisely not against the whole database contents, but rather only against the filtered subset. Namely, a consultation is performed to the filtered subset of the table contents based on the query statement. By being limited to the subset generated by sweeping the filter over the whole tables, the consultation avoids consulting redundant data and is hence quicker.

In operation S7, the query result from the consultation is returned, thereby completing the processing of the query statement.

Data redundancy is considered insignificant in the following types of query data blocks, because either duplicates are removed later, or because the presence of duplicates does not alter the semantics of the query data block:
(1) query data blocks with the DISTINCT operator
(2) query data blocks with aggregate functions such as ROW_NUMBER( ) OVER(PARTITION BY), COUNT( ), or SUM( ) with/without a GROUP-BY clause
(3) query blocks with no aggregate functions and a GROUP-BY clause
(4) branches of UNION, INTERSECT, and MINUS query data blocks
(5) semi-joined and anti-joined views
(6) occurrences of ANY, ALL, [NOT] IN, and [NOT] EXISTS subqueries
(7) occurrences when redundant insignificant attributes can be inherited recursively from the containing query data block by views and by the branches of UNION ALL, INTERSECT, MINUS, and UNION query blocks.

Query data redundancy nullification is useful for a query data block that is redundant and insignificant, such as for a query data block that includes the DISTINCT operator or a query data block that contains UNION, INTERSECT, or MINUS operators. For other types of redundant insignificant query blocks, removal of duplicates is not mandatory; however, removal of duplicates in such cases can make post-join operations (e.g., GROUP-BY, subsequent joins, etc.) more efficient.

Embodiments of the disclosure may be implemented using multiple such probabilistic data structure filters, where the multiple filters may include thread memory processing on a multi-core processing device.

A practical example of processing a query statement according to embodiments of the disclosure is now presented. The example contains a JOIN query statement between tables T1, T2 and using the SQL query statement Q1:
CREATE TABLE T1 (A INT, B INT, C INT);
INSERT INTO T1 VALUES (20, 13, 2);
INSERT INTO T1 VALUES (2, 6, 5);
INSERT INTO T1 VALUES (20, 2, 2);
INSERT INTO T1 VALUES (20, 4, 3);
INSERT INTO T1 VALUES (2, 4, 5);
CREATE TABLE T2 (A INT, B INT, C INT);
INSERT INTO T2 VALUES (2, 10, 7);
INSERT INTO T2 VALUES (2, 20, 7);
INSERT INTO T2 VALUES (5, 2, 4);
INSERT INTO T2 VALUES (3, 20, 1);
INSERT INTO T2 VALUES (3, 10, 1);
Q1:
SELECT SUM(DISTINCT T1.A), MIN(T2.C)
FROM T1, T2
WHERE T1.A=T2.B;

Initially a 3-bit probabilistic filter of size 7 (running from 0 to 6) for Table T1, Column A is created. The hash function is defined so that 20 hashes to 2, and 2 hashes to 4.

After processing the first row (20, 13, 2), the probabilistic filter becomes defined as:
000 000 100 000 000 000 000

since the first bit in the bit group 2 is set. Then, after processing the next row (2, 6, 5), the probabilistic filter becomes:
000 000 100 000 100 000 000

since the first bit in the bit group 4 is set. After processing row (20, 2, 2), the probabilistic filter becomes:
000 000 110 000 100 000 000

since the second bit in the bit group 2 is set. After processing row (20, 4, 3), the probabilistic filter becomes:
000 000 111 000 100 000 000

since the third bit in the bit group 2 is set. Finally, after processing row (2, 4, 5), the probabilistic filter becomes:
000 000 111 000 110 000 000

since the second bit in the bit group 4 is set.

From Table T1 filter, the conclusion for condition ‘DISTINCT T1.A’ are the values 20 and 2, represented respectively by the bit values 111 (2nd position in the filter) and 110 (4th position in the filter), where 111 means that we have the value 20 for Column A repeated 3 times (1st, 3rd, and 4th rows), and where 110 means that we have the value 2 for Column A repeated 2 times (2nd and 5th rows).

For Table T2, Column B, considering the same hashes as stated above for Table T1, plus that 10 hashes to 6:

Initially, after processing the first row (2, 10, 7), the probabilistic filter becomes defined as:
000 000 000 000 000 000 100

Then, after processing the next row (2, 20, 7), the probabilistic filter becomes:
000 000 100 000 000 000 100

After processing row (5, 2, 4), the probabilistic filter becomes:
000 000 100 000 100 000 100

After processing row (3, 20, 1), the probabilistic filter becomes:
000 000 110 000 100 000 100

Finally, after processing row (3, 10, 1), the probabilistic filter becomes:
000 000 110 000 100 000 110

From table T2 filter, the conclusion for condition ‘T2.B’ are the values 20, 2 and 10, represented respectively by the bit values 110 (2nd position in the filter), 100 (4th position in the filter) and 110 (6th position in the filter), where 110 means that we have the value 20 for Column B repeated 2 times (2nd and 4th rows), where 100 means that we have the value 2 for Column B occurring only once (3rd row), and where 110 means that we have the value 10 for Column B repeated 2 times (1st and 5th rows).

Now considering the condition ‘T1.A=T2.B’ from the first filter and second filter, this means that the value 10 (table T2 column B) is eliminated by the JOIN combination:
000 000 111 000 110 0 000 for T1, and
000 000 110 000 100 000 110 for T2
   which results in (after ANDing):
000 000 110 000 100 000 000

Considering that the JOIN filter outputs the values 10 and 2 for condition ‘T1.A=T2.B’ (2nd, 3rd and 4th rows in table T2), the condition ‘MIN(T2.C)’ is then found in this same rows in Table T2, i.e., MIN(T2.C)=MIN(7, 4, 1)=1. Further considering both conditions ‘T1.A=T2.B’ and ‘SUM(DISTINCT T1.A)’ from the select output from query Q1, and based on both filter JOIN we can determine that
SUM(DISTINCT T1.A)=SUM(20+2)=22

i.e., distinct values for Table T1, Column A where the same values are verified in table T2.

The final output for query Q1 is then the result set “22, 1”.

It will be clear to one of ordinary skill in the art that all or part of the logical process operations of the preferred embodiment may be alternatively embodied in a logic apparatus, or a plurality of logic apparatus, including logic elements arranged to perform the logical process operations of the method and that such logic elements may include hardware components, firmware components or a combination thereof.

It will be equally clear to one of skill in the art that all or part of the logic components of the preferred embodiment may be alternatively embodied in logic apparatus including logic elements to perform the operations of the method, and that such logic elements may include components such as logic gates in, for example, a programmable logic array (PLA) or application-specific integrated circuit (ASIC). Such a logic arrangement may further be embodied in enabling elements for temporarily or permanently establishing logic structures in such an array or circuit using, for example, a virtual hardware description language (VHDL), which may be stored and transmitted using fixed or transmittable carrier media.

In a further alternative embodiment, the present disclosure may be realized in the form of a computer-implemented method of deploying a service including operations of deploying computer program operable to, when deployed into a computer infrastructure and executed thereon, cause the computing device to perform all the operations of the method.

It can be appreciated that the method and components of the preferred embodiment may alternatively be embodied fully or partially in a parallel computing system including two or more processors for executing parallel software.

Embodiments of the present disclosure can include a computer program product defined in terms of a system and method. The computer program product may include a computer-readable storage medium, or media, having computer-readable program instructions thereon for causing a processor to carry out aspects of the present disclosure.

The computer-readable storage medium can be a tangible device that can retain and store instructions for use by an instruction execution device

Embodiments of the present disclosure may be a system, a method, and/or a computer program product. The computer program product can include a computer-readable storage medium, or media, having computer-readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (for example light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein includes an article of manufacture including instructions which implement aspects of the function/act specified in the flowchart and/or block diagram block or blocks.

The computer-readable program instructions may also be loaded onto a computer, other programmable data processing apparatus, or other device to cause a series of operational operations to be performed on the computer, other programmable apparatus or other device to produce a computer-implemented process, such that the instructions which execute on the computer, other programmable apparatus, or other device implement the functions/acts specified in the flowchart and/or block diagram block or blocks.

It can be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

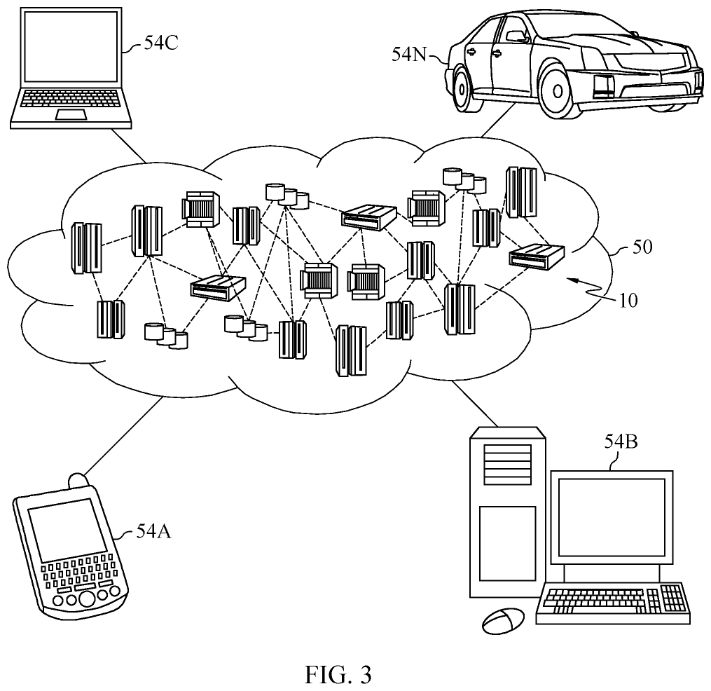

Referring now to FIG. 3, illustrative cloud computing environment 50 is depicted. As depicted, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N depicted in FIG. 10 are intended to be illustrative only and that computing nodes 10 and cloud computing environment 50 can communicate with any type of computerized device over any type of network and/or network addressable connection (e.g., using a web browser).

An add-on according to embodiments of the disclosure may be installed in a web browser in the environment of FIG. 3 as follows. One of the cloud computing nodes 10 may host a website from which the add-on may on request be downloaded to a third party computing device such as any of the computing devices 54A, 54B and 54C. The request causes the add-on to be sent from the node 10 via a network connection to the computing device 54A/54B/54C, where the add-on is sent together with an installer for integrating the add-on with a web browser already present on the computing device.

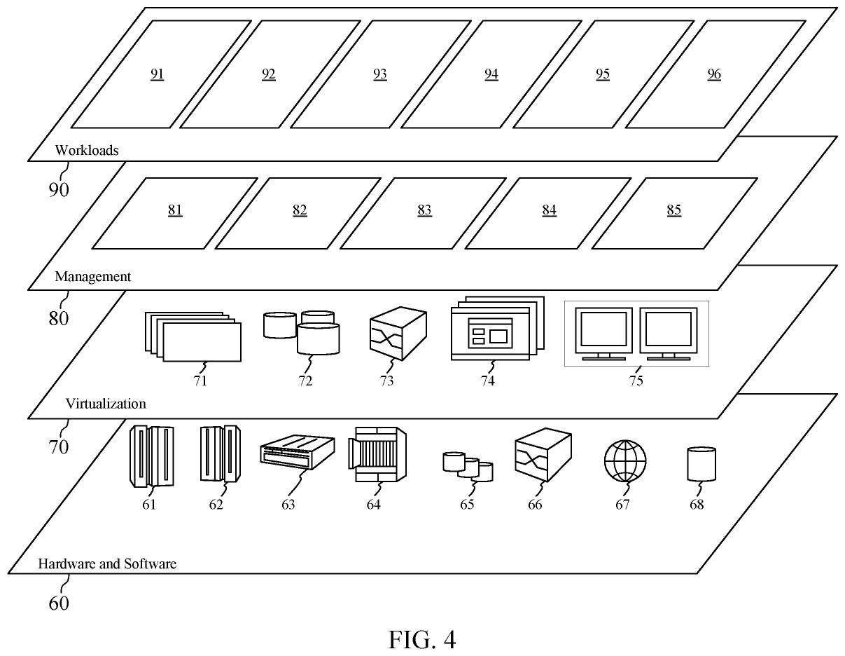

Referring now to FIG. 4, a set of functional abstraction layers provided by cloud computing environment 50 (FIG. 3) is depicted. It should be understood in advance that the components, layers, and functions depicted in FIG. 4 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software lifecycle management 92; virtual classroom education delivery 93; data analytics processing 94; transaction processing 95; and a DMPS 96 according to embodiments of the disclosure.

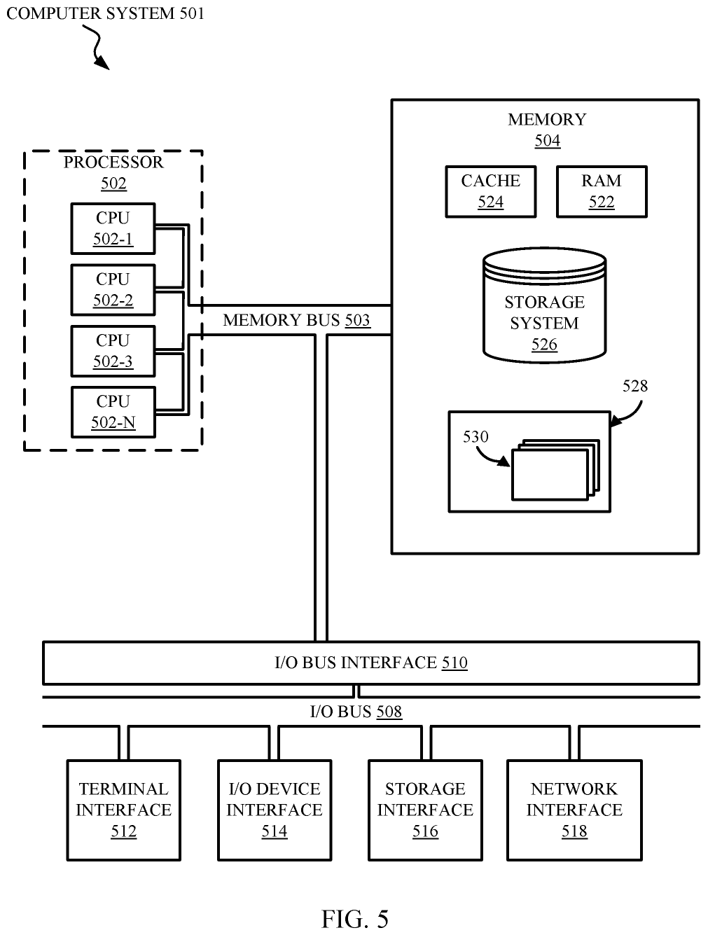

Referring now to FIG. 5, shown is a high-level block diagram of an example computer system 501 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 501 may comprise one or more CPUs 502, a memory subsystem 504, a terminal interface 512, a storage interface 516, an I/O (Input/Output) device interface 514, and a network interface 518, all of which may be communicatively coupled, directly or indirectly, for inter-component communication via a memory bus 503, an I/O bus 508, and an I/O bus interface unit 510.

The computer system 501 may contain one or more general-purpose programmable central processing units (CPUs) 502A, 502B, 502C, and 502D, herein generically referred to as the CPU 502. In some embodiments, the computer system 501 may contain multiple processors typical of a relatively large system; however, in other embodiments the computer system 501 may alternatively be a single CPU system. Each CPU 502 may execute instructions stored in the memory subsystem 504 and may include one or more levels of on-board cache.

System memory 504 may include computer system readable media in the form of volatile memory, such as random access memory (RAM) 522 or cache memory 524. Computer system 501 may further include other removable/non-removable, volatile/non-volatile computer system storage media. By way of example only, storage system 526 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 504 can include flash memory, e.g., a flash memory stick drive or a flash drive. Memory devices can be connected to memory bus 503 by one or more data media interfaces. The memory 504 may include at least one program product having a set (e.g., at least one) of program modules that are configured to carry out the functions of various embodiments.

Although the memory bus 503 is shown in FIG. 5 as a single bus structure providing a direct communication path among the CPUs 502, the memory subsystem 504, and the I/O bus interface 510, the memory bus 503 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 510 and the I/O bus 508 are shown as single respective units, the computer system 501 may, in some embodiments, contain multiple I/O bus interface units 510, multiple I/O buses 508, or both. Further, while multiple I/O interface units are shown, which separate the I/O bus 508 from various communications paths running to the various I/O devices, in other embodiments some or all of the I/O devices may be connected directly to one or more system I/O buses.

In some embodiments, the computer system 501 may be a multi-user mainframe computer system, a single-user system, or a server computer or similar device that has little or no direct user interface, but receives requests from other computer systems (clients). Further, in some embodiments, the computer system 501 may be implemented as a desktop computer, portable computer, laptop or notebook computer, tablet computer, pocket computer, telephone, smart phone, network switches or routers, or any other appropriate type of electronic device.

It is noted that FIG. 5 is intended to depict the representative major components of an exemplary computer system 501. In some embodiments, however, individual components may have greater or lesser complexity than as represented in FIG. 5, components other than or in addition to those shown in FIG. 5 may be present, and the number, type, and configuration of such components may vary.

One or more programs/utilities 528, each having at least one set of program modules 530 may be stored in memory 504. The programs/utilities 528 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 528 and/or program modules 503 generally perform the functions or methodologies of various embodiments.

It will be clear to one skilled in the art that many improvements and modifications can be made to the foregoing exemplary embodiment without departing from the scope of the present disclosure.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method of performing a database query on a database containing at least one table comprising one or more rows and columns, the method comprising:
receiving a query statement;
creating a probabilistic data structure filter from the query statement, wherein the probabilistic data structure filter specifies consultation to data in at least one table at a level of at least one of: rows and columns;
removing any data from the at least one table that are redundant to the query statement as determined by applying the probabilistic data structure filter to generate a filtered subset of the at least one table;
performing consultation to the filtered subset based on the query statement, whereby the consultation avoids consultation to the redundant data; and
returning a query result from the consultation.

2. The method of claim 1, wherein the probabilistic data structure filter specifies consultation to data in one or more tables in the database at a level of both individual rows and individual columns.

3. The method of claim 1, wherein said performing is preceded by parsing and optimizing the query statement.

4. The method of claim 1, wherein the probabilistic data structure filter is created having regard to a layout of the at least one table.

5. The method of claim 1, wherein the probabilistic data structure filter is created at a run time for each query statement.

6. The method of claim 1, wherein the probabilistic data structure filter is a Bloom filter.

7. The method of claim 1, wherein the probabilistic data structure filter is a cuckoo filter.

8. The method of claim 1, wherein the probabilistic data structure filter is a quotient filter.

9. The method of claim 1, wherein, the query statement is written in SQL.

10. A database management system comprising:
a database configured to store at least one table comprising rows and columns;
a processing node including a processor capable of running database queries against the database to generate a query result; and
a query processor having an input configured to receive database queries, an output configured to output query results, and an interface to the processing node configured to supply database queries to and receive query results from the processing node,
wherein the processing node includes a filter unit operable to:
create a probabilistic data structure filter from a query statement, wherein the probabilistic data structure filter specifies consultation to data in at least one table at a level of at least one of rows and columns; and
remove any data from the at least one table that are redundant to the query statement as determined by applying the probabilistic data structure filter to generate a filtered subset of the at least one table;
wherein the processor is operable to:
perform consultation to the filtered subset based on the query statement, whereby the consultation avoids consultation to the redundant data.

11. The system of claim 10, wherein the probabilistic data structure filter is a Bloom filter.

12. The system of claim 10, wherein the probabilistic data structure filter is a cuckoo filter.

13. The system of claim 10, wherein the probabilistic data structure filter is a quotient filter.

14. A computer program product for performing a database query on a database containing at least one table comprising one or more rows and columns, the computer program product comprising a computer-readable storage medium having program instructions embodied therewith, the program instructions executable by a computer to cause the computer to perform a method comprising:
receiving a query statement;
creating a probabilistic data structure filter from the query statement, wherein the probabilistic data structure filter specifies consultation to data in at least one table at a level of at least one of: rows and columns;
removing any data from the at least one table that are redundant to the query statement as determined by applying the probabilistic data structure filter to generate a filtered subset of the at least one table;
performing consultation to the filtered subset based on the query statement, whereby the consultation avoids consultation to the redundant data; and
returning a query result from the consultation.

15. The computer program product of claim 14, wherein the probabilistic data structure filter specifies consultation to data in one or more tables in the database at a level of both individual rows and individual columns.

16. The computer program product of claim 14, wherein said performing is preceded by parsing and optimizing the query statement.

17. The computer program product of claim 14, wherein the probabilistic data structure filter is created having regard to a layout of the at least one table.

18. The computer program product of claim 14, wherein the probabilistic data structure filter is created at a run time for each query statement.

19. The computer program product of claim 14, wherein the probabilistic data structure filter is a Bloom filter.

20. The computer program product of claim 14, wherein the probabilistic data structure filter is a cuckoo filter.
